(19) United States
(12) Patent Application Publication
(10) Pub. No.: US 2015/0172714 A1
(43) Pub. Date: Jun. 18, 2015

(54) METHOD AND APPARATUS of INTER-VIEW SUB-PARTITION PREDICTION in 3D VIDEO CODING

(71) Applicant: MEDIATEK INC., Hsin-Chu, TW (TW)

(72) Inventors: Chi-Ling Wu, Taipei (TW); Yu-Lin Chang, Taipei (TW); Yu-Pao Tsai, Kaohsiung (TW); Shaw-Min Lei, Hsinchu County (TW)

(21) Appl. No.: 14/412,197

(22) PCT Filed: Jun. 28, 2013
(86) PCT No.: PCT/CN2013/078391

§ 371 Date: Dec. 30, 2014

Related U.S. Application Data
(60) Provisional application No. 61/669,364, filed on Jul. 9, 2012.
(60) Provisional application No. 61/712,926, filed on Oct. 12, 2012.

(51) Int. Cl. H04N 19/597; H04N 19/176

(52) U.S. Cl. CPC H04N 19/597; H04N 19/176

(57) ABSTRACT

A method and apparatus for three-dimensional video encoding or decoding using sub-block based inter-view prediction are disclosed. The method partitions a texture block into texture sub-blocks and determines disparity vectors of the texture sub-blocks. The inter-view reference data is derived based on the disparity vectors of the texture sub-blocks and a reference texture frame in a different view. The inter-view reference data is then used as prediction of the current block for encoding or decoding. One aspect of the present invention addresses partitioning the current texture block. Another aspect of the present invention addresses derivation of disparity vectors for the current texture sub-blocks.

### CROSS REFERENCE TO RELATED APPLICATIONS

The present invention claims priority to U.S. Provisional Patent Application, Ser. No. 61/669,364, filed Jul. 9, 2012, entitled “Inter-view prediction with sub-partition scheme in 3D video coding” and U.S. Provisional Patent Application, Ser. No. 61/712,926, filed Oct. 12, 2012, entitled “Inter-view sub-partition prediction integrated with the motion compensation module in 3D video coding”. The U.S. Provisional Patent Applications are hereby incorporated by reference in their entireties.

### TECHNICAL FIELD

The present invention relates to three-dimensional video coding. In particular, the present invention relates to inter-view sub-partition prediction in 3D video coding.

### BACKGROUND

Three-dimensional (3D) television has been a technology trend in recent years that intends to bring viewers sensational viewing experience. Various technologies have been developed to enable 3D viewing. Among them, the multi-view video is a key technology for 3DTV application among others. The traditional video is a two-dimensional (2D) medium that only provides viewers a single view of a scene from the perspective of the camera. However, the multi-view video is capable of offering arbitrary viewpoints of dynamic scenes and provides viewers the sensation of realism.

The multi-view video is typically created by capturing a scene using multiple cameras simultaneously, where the multiple cameras are properly located so that each camera captures the scene from one viewpoint. Accordingly, the multiple cameras will capture multiple video sequences corresponding to multiple views. In order to provide more views, more cameras have been used to generate multi-view video with a large number of video sequences associated with the views. Accordingly, the multi-view video will require a large storage space to store and/or a high bandwidth to transmit. Therefore, multi-view video coding techniques have been developed in the field to reduce the required storage space or the transmission bandwidth.

A straightforward approach may be to simply apply conventional video coding techniques to each single-view video sequence independently and disregard any correlation among different views. Such coding system would be very inefficient. In order to improve efficiency of multi-view video coding, typical multi-view video coding exploits inter-view redundancy. Therefore, most 3D Video Coding (3DVC) systems take into account of the correlation of video data associated with multiple views and depth maps. The standard development body, the Joint Video Team of the ITU-T Video Coding Experts Group (VCEG) and the ISO/IEC Moving Picture Experts Group (MPEG), extended H.264/MPEG-4 AVC to multi-view video coding (MVC) for stereo and multi-view videos.

The MVC adopts both temporal and spatial predictions to improve compression efficiency. During the development of MVC, some macroblock-level coding tools are proposed, including illumination compensation, adaptive reference filtering, motion skip mode, and view synthesis prediction. These coding tools are proposed to exploit the redundancy between multiple views. Illumination compensation is intended for compensating the illumination variations between different views. Adaptive reference filtering is intended to reduce the variations due to focus mismatch among the cameras. Motion skip mode allows the motion vectors in the current view to be inferred from the other views. View synthesis prediction is applied to predict a picture of the current view from other views.

In the MVC, however, the depth maps and camera parameters are not coded. In the recent standardization development of new generation 3D Video Coding (3DVC), the texture data, depth data, and camera parameters are all coded. For example, FIG. 1 illustrates generic prediction structure for 3D video coding, where a standard conforming video coder is used for the base-view video. The incoming 3D video data consists of images (110-0, 110-1, 110-2, . . . ) corresponding to multiple views. The images collected for each view form an image sequence for the corresponding view. Usually, the image sequence 110-0 corresponding to a base view (also called an independent view) is coded independently by a video coder 130-0 conforming to a video coding standard such as H.264/AVC or HEVC (High Efficiency Video Coding). The video coders (130-1, 130-2, . . . ) for image sequences associated with the dependent views (i.e., views 1, 2, . . . ) further utilize inter-view prediction in addition to temporal prediction. The inter-view predictions are indicated by the short-dashed lines in FIG. 1.

In order to support interactive applications, depth maps (120-0, 120-1, 120-2, . . . ) associated with a scene at respective views are also included in the video bitstream. In order to reduce data associated with the depth maps, the depth maps are compressed using depth map coder (140-0, 140-1, 140-2, . . . ) and the compressed depth map data is included in the bit stream as shown in FIG. 1. A multiplexer 150 is used to combine compressed data from image coders and depth map coders. The depth information can be used for synthesizing virtual views at selected intermediate viewpoints. An image corresponding to a selected view may be coded using inter-view prediction based on an image corresponding to another view. In this case, the image for the selected view is referred as dependent view.

Since the depth data and camera parameters are also coded in the new generation 3DVC, the relationship between the texture images and depth maps may be useful to further improve compression efficiency. The depth maps and texture images have high correlation since they correspond to different aspects of the same physical scene. The correlation can be exploited to improve compression efficiency or to reduce required computation load. Furthermore, the depth maps can be used to represent the correspondence between two texture images. Accordingly, the depth maps may be useful for the inter-view prediction process.

### SUMMARY

A method and apparatus for three-dimensional video encoding or decoding using sub-block based inter-view prediction are disclosed. The method of sub-block based inter-view prediction according to an embodiment of the present invention comprises receiving first data associated with the current block of the current frame in the current view; partitioning the current block into current sub-blocks; determining disparity vectors of the current sub-blocks; deriving inter-view reference data and applying inter-view predictive encoding or decoding to the first data based on the inter-view reference data. The inter-view reference data is derived from a reference frame based on the disparity vectors of the current sub-blocks, wherein the reference frame and the current frame have a same time stamp and correspond to different views. For encoding, the first data corresponds to pixel data or depth data associated with the current block. For decoding, the first data corresponds to residue data of texture or depth of the current block. An interview Skip mode is signaled for the current block if motion information and the residue data are omitted and an interview Direct mode is signaled for the current texture block if motion information is omitted and the residue data is transmitted.

One aspect of the present invention addresses partitioning the current block. The current block can be partitioned into equal-sized rectangular or square sub-blocks, or arbitrary shaped sub-blocks. The current block can be partitioned into equal-sized square sub-blocks corresponding to 4×4 sub-blocks or 8×8 sub-blocks and indication of the 4×4 sub-blocks or the 8×8 sub-blocks can be signaled in Sequence Parameter Set (SPS) of the bitstream. The equal-sized square sub-blocks may correspond to n×n sub-blocks and n is signaled in the sequence level, slice level, or coding unit (CU) level of the bitstream.

Another aspect of the present invention addresses derivation of disparity vectors for the current sub-blocks. In one embodiment, the inter-view reference data for the current block is obtained from the corresponding sub-blocks of the reference frame and the corresponding sub-blocks are determined based on the disparity vectors of the current sub-blocks. The disparity vectors of the current sub-blocks can be determined based on the depth values of the collocated sub-blocks in a depth map corresponding to the current block. The disparity vectors of the current sub-blocks may also be obtained from the neighboring disparity vectors associated with the neighboring sub-blocks of the current block coded in an inter-view mode.

### BRIEF DESCRIPTION OF DRAWINGS

FIG. 1 illustrates an example of prediction structure for a three-dimensional video coding system.

FIG. 2 illustrates an example of prediction based on spatial neighboring blocks, temporal collocated blocks, and inter-view collocated block in three-dimensional (3D) video coding.

FIG. 3 illustrates an example of sub-block based inter-view prediction according to an embodiment of the present invention, where the current texture block is divided into 4 square sub-blocks.

FIG. 4 illustrates another example of sub-block based inter-view prediction according to an embodiment of the present invention, where the current texture block is divided into 4×4 square sub-blocks.

FIG. 5 illustrates an example of sub-block based inter-view prediction according to an embodiment of the present invention, where the current texture block is divided into arbitrary shaped sub-blocks according to the associated depth map.

FIG. 6 illustrates an example of derivation of disparity vectors for current texture sub-blocks based on neighboring disparity vectors of neighboring blocks.

FIG. 7 illustrates an exemplary flowchart for a system incorporating sub-block based inter-view prediction according to an embodiment of the present invention.

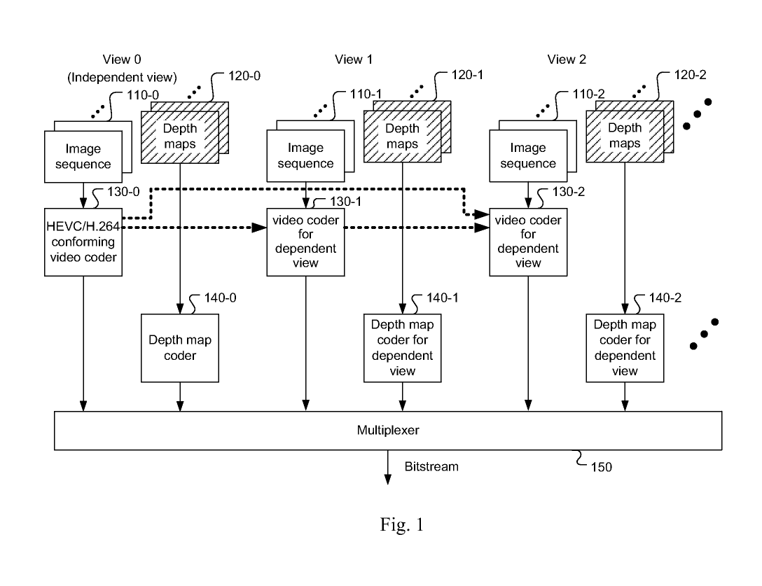

### DETAILED DESCRIPTION

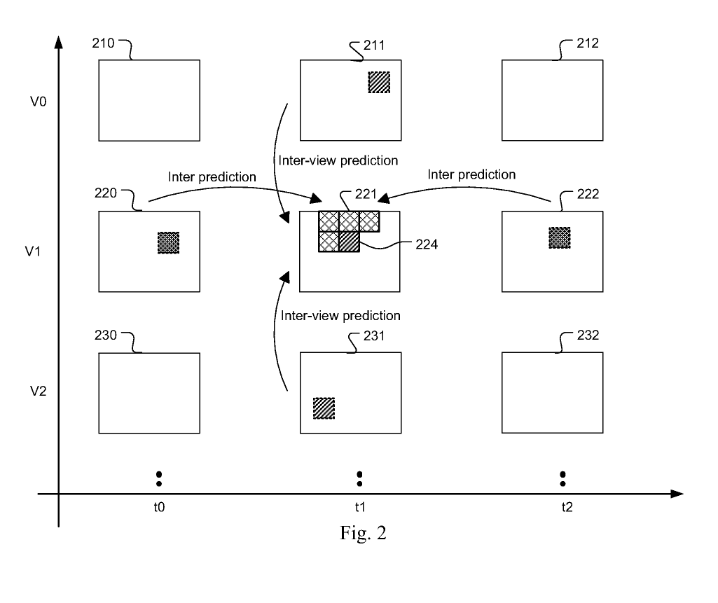

FIG. 2 illustrates an example where prediction for a current block is derived from spatially neighboring blocks, temporally collocated blocks in the collocated pictures, and inter-view collocated blocks in the inter-view collocated picture. Pictures 210, 211 and 212 correspond to pictures from view V0 at time instances t0, t1 and t2 respectively. Similarly, pictures 220, 221 and 222 correspond to pictures from view V1 at time instances t0, t1 and t2 respectively and pictures 230, 231 and 232 correspond to pictures from view V2 at time instances t0, t1 and t2 respectively. The pictures shown in FIG. 2 can be the color images or the depth images. For a current picture, Intra/Inter prediction can be applied based on pictures in the same view. For example, prediction for current block 224 in current picture 22l can be based on surrounding blocks of picture 221 (i.e., Intra prediction). Prediction for current block 224 can use information from other pictures, such as pictures 220 and 222 in the same view (i.e., Inter prediction). Furthermore, prediction for current block 224 can also use information from collocated pictures from other views, such as pictures 211 and 231 (i.e., inter-view prediction).

In a system incorporating an embodiment of the present invention, an inter-view prediction method with sub-partition scheme is used to save computation time and reduce the complexity without sacrificing coding efficiency. In one embodiment, the current block is first partitioned into sub-blocks and the correspondences of the partitioned sub-blocks are obtained from another view as the reference. The corresponding sub-blocks from another view is then used as the predictor for the current sub-blocks to generate residuals and the residuals are coded/decoded. In this disclosure, the coding mode that the current block refers to the reference frame with the same time stamp but different view is named as an inter-view mode. Furthermore, the inter-view mode that partitions a block into sub-blocks and codes the sub-blocks using corresponding sub-blocks in a reference picture from other views is referred to as a sub-block inter-view mode. In addition, sub-block inter-view Skip/Direct modes can be included, where the sub-block inter-view Skip mode is used when there is no residual to be coded/decoded and the sub-block inter-view Direct mode is used when there is no motion information needs to be coded/decoded. In these modes, the disparity of the sub-blocks can be obtained from the coded depth in the encoder, the decoded depth in the decoder, or the estimated depth map in the encoder and the decoder.

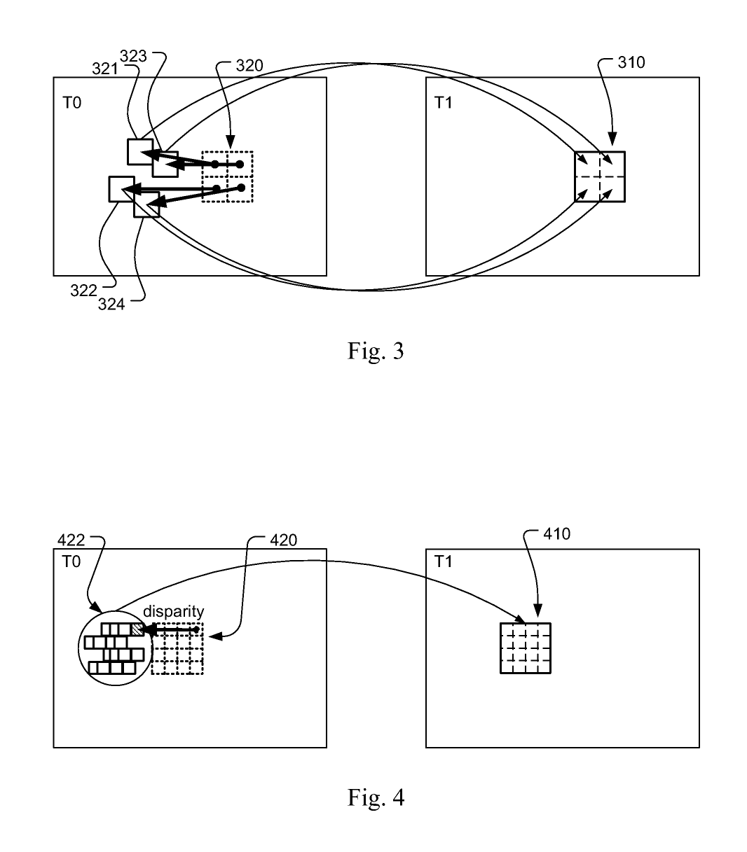

FIG. 3 illustrates one example of the sub-block inter-view mode with four square sub-blocks according to one embodiment of the present invention. When the current block in a texture frame of view 1 (i.e., T1) is coded or decoded, it is assumed that the depth map of view 1 (i.e., D1) has been coded/decoded or estimated. Therefore, depth information from D1 can be used for coding or decoding of texture information of T1. The current texture block (310) is partitioned into sub-blocks and the sub-blocks find their corresponding sub-blocks (321 to 324) in the reference frame corresponding to view 0 (i.e., T0) according to disparity vectors. The corresponding sub-blocks (321 to 324) in the reference frame are used as inter-view reference data to encode or decode current block 310. There are multiple ways to derive disparity vectors for the current block. For example, the corresponding sub-blocks (321 to 324) can be determined based on the collocated block (320) in T0 and depth information in D1. The derived disparity vectors are shown as thick arrow lines in FIG. 3. The residuals between the current block and the corresponding sub-blocks in T0 are generated and coded. When there is no need to code the residuals and the associated motion information, the inter-view mode becomes an inter-view Skip mode. In the case that the motion information can be inferred and only residuals need to be transmitted, the inter-view mode becomes the inter-view Direct mode.

The partitioning process according to the present invention may correspond to partitioning the current block into regular shapes such as rectangles or squares, or into arbitrary shapes. For example, the current block can be partitioned into 4×4 or 8×8 squares and the partitioning information can be signaled in the sequence level syntax such as Sequence Parameter Set (SPS) in 3D video coding. The 4×4 squares in this disclosure refer to the partitioning that results in 4 rows of squares and 4 columns of squares. Similarly, the 8×8 squares in this disclosure refer to the partitioning that results in 8 rows of squares and 8 columns of squares. While 4×4 and 8×8 partitions are mentioned above, the current block can be partitioned into n×n sub-blocks, where n is an integer and the partition information can be signaled in the bitstream. Again, the n×n partitions in this disclosure refer to the partitioning that results in n rows of squares and n columns of squares. The sub-block partition parameter, i.e., n can be signaled in the sequence level (SPS) or the slice level. The size of the sub-block can be equal to the smallest size of motion compensation block as specified in the system. An example of partitioning a block into 4×4 sub-blocks is shown in FIG. 4, where sub-blocks 410 are located in T1 of the current view (i.e., view 1) and sub-blocks 420 are the collocated sub-blocks in T0 of the view 0. There are various ways to derive the corresponding sub-blocks. For example, corresponding sub-blocks (422) in T0 can be derived based on the collocated sub-blocks (420) and corresponding depth information of D1 associated with view 1. The disparity vector for one of the sub-blocks is shown as a thick arrow line. The corresponding sub-blocks in T0 are used as predictors for sub-blocks 410 in T1 for encoding or decoding.

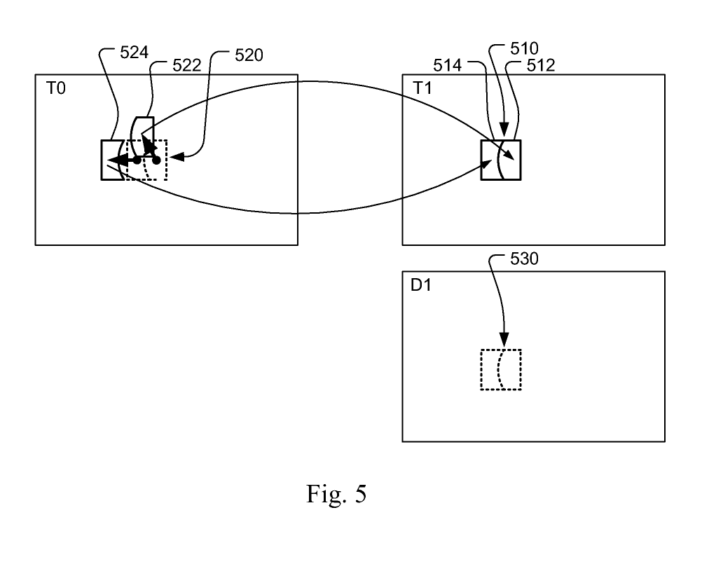

FIG. 5 illustrates an example of partitioning a current block into arbitrary shapes. The current block can be partitioned into arbitrary shapes according to a selected criterion. For example, the current block (510) can be partitioned along the object boundaries into two parts (512 and 514) according to the edges in the depth map as shown in FIG. 5. Again, there are various ways to determine the disparity vectors associated with the arbitrary shaped sub-blocks. For example, the two corresponding sub-blocks (522 and 524) can be derived based on collocated block 520 in T0 and collocated depth block 530 in D1. The disparity vectors for the two sub-blocks are indicated by the thick arrow lines. As mentioned before, when the current block in the texture frame T1 is encoded or decoded, it is assumed that the collocated depth block in the depth map D1 has been coded or decoded, or can be estimated by a known method.

The above examples of sub-block inter-view mode can also be applied to depth map coding. In an embodiment, a current depth block in a depth frame of a current view (i.e., T1) is partitioned into sub-blocks and the sub-blocks find their corresponding sub-blocks in a reference depth frame corresponding to another view (i.e., T0). The corresponding sub-blocks in the reference depth frame are used as inter-view reference data to encode or decode the current depth block.

After the current block is partitioned into multiple sub-blocks, the correspondences of the sub-blocks can be obtained from the depth map or the disparity values of the coded/decoded neighboring blocks according to another embodiment of the present invention. In 3D video coding, the depth map for a current block always exists, and the depth map is already coded/decoded or can be estimated. When the correspondences of the sub-blocks are obtained from the depth map, the disparity value of the sub-block can be derived from the maximum, minimum, median, or average of all depth samples or partial depth samples within the collocated sub-block in the depth map. When the correspondences of the sub-blocks are obtained from the disparity vectors of the coded or decoded neighboring blocks, the disparity vector of the sub-block can be inferred from the neighboring blocks that are coded or decoded in the inter-view mode.

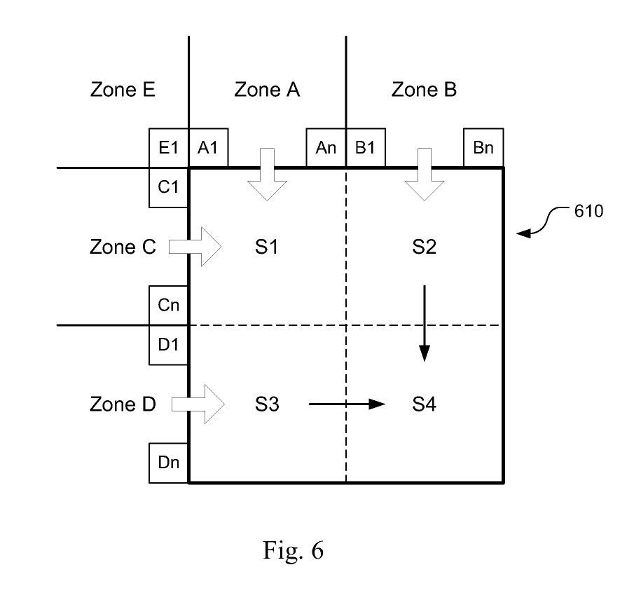

FIG. 6 illustrates an example of deriving the disparity vector for four square sub-blocks from the coded neighbors. The current block (610) is partitioned into four sub-blocks, i.e., S1, S2, S3, and S4. The neighboring blocks are divided into zones (i.e., Zone A-Zone E) according to their locations. For example, blocks A1, . . . , An belong to Zone A and blocks B1, . . . , Bn belong to Zone B, and so on. It is assumed that at least one block in each zone is coded in the inter-view mode. Therefore, sub-blocks S1, S2, and S3 are adjacent to the neighboring blocks, where at least one neighboring block is coded or decoded in the inter-view mode. For sub-block S1, the disparity vector can be derived from the blocks coded in the inter-view mode in Zones A, C, and E. Similarly, the disparity vectors for sub-blocks S2 and S3 can be derived from the neighboring blocks coded in the inter-view mode in Zone B and D respectively. When there are multiple candidates, the disparity vector derivation for the sub-block can be based on the maximum, minimum, average, or median of the disparity vectors of all or some neighboring blocks coded in the inter-view mode.

Since sub-block S4 is not adjacent to any inter-view neighboring blocks, the disparity of sub-block S4 may be implicitly derived from sub-blocks S1, S2, and S3. There are several ways to obtain the disparity vector for sub-block S4 according to embodiments of the present invention. In addition, an explicit signal can be used to indicate which derivation method is selected. In the first embodiment, the disparity vector for sub-block S4 is set to the disparity vector of sub-block S3 if the disparity vector of sub-block S1 is closer to the disparity vector of sub-block S2. Otherwise, the disparity vector for sub-block S4 is set to the disparity vector of sub-block S2. The similarity between two disparity vectors may be measured based on the distance between two points corresponding to the two disparity vectors mapped into a Cartesian coordinate system. Other distance measurement may also be used. In the second embodiment, the disparity vector for sub-block S4 is the weighted sum of the disparity vectors associated with sub-blocks S1, S2 and S3. The weight is inversely proportional to the distance. In the third embodiment, the disparity vector for sub-block S4 is set to the disparity vector of sub-blocks S1, S2 or S3 according to a selection signal. In the fourth embodiment, the disparity vector for sub-block S4 is equal to the disparity vector of the collocated block in a previous coded frame if the collocated block has a disparity value. In the fifth embodiment, the disparity vector for sub-block S4 is equal to the derived disparity vector from the depth information of the collocated block in the previous coded frame. In the sixth embodiment, the disparity vector for sub-block S4 may be derived based on spatial neighbors or a temporal collocated block as indicated by a signal. In the sixth embodiment, the disparity vector for sub-block S4 is derived from the coded/decoded or estimated depth value.

Furthermore, in one embodiment of the present invention, a flag is used to indicate whether the sub-block inter-view mode is enabled. The flag can be incorporated in the sequence level (e.g., SPS) of the bitstream, where all frames in the sequence share the same flag. The flag can be incorporated in a slice level, where all coding blocks in a slice share the same flag. The flag can also be signaled for each coding block. Furthermore, the flag can be adaptively incorporated according to the mode information of the adjacent blocks around the current block. If the majority of the adjacent blocks use the inter-view mode, the flag is placed in a higher priority position than non-interview modes.

The derivation of inter-view reference data for a current block can be performed using existing processing module for motion compensation (i.e., motion compensation module). It is well known in the art that the motion compensation module provides motion compensated data for Inter prediction. The inputs to the motion compensation module include the reference picture and the motion vectors. In some system, a reference index may be used to select a set of reference pictures. In one embodiment of the present invention, the motion compensation module receives one or more disparity vectors and treats them as the motion vectors. The inter-view reference frame is used as the reference picture by the motion compensation module. Optionally, the inter-view reference indices may be used by the motion compensation module to select the set of reference pictures. The motion compensation module will output the inter-view reference data based on corresponding sub-blocks of the reference frame for the current block. The inter-view reference data is then used as prediction for coding or decoding of the current block. After the inter-view reference data is obtained, the motion information is no longer needed and can be cleared. In the motion compensation module, the motion information can be cleared by setting the motion information as non-available. Similarly, the motion vectors can be cleared by setting the motion vectors as zero motion and the reference indices and pictures can be cleared by setting them as non-available.

The inter-view mode with sub-partition scheme can be applied to different partition block sizes and each partition uses one flag to indicate if the inter-view mode is enabled. The sub-block based inter-view coding and decoding as disclosed above can be used for view synthesized prediction. The same technique can also be applied to partition a coding unit (CU) in 3D video coding, where the CU is a unit for coding and decoding of a frame as defined in the High Efficiency Video Coding (HEVC) standard being developed. In this case, a CU becomes a block to be partitioned to generate inter-view reference data based on the corresponding sub-blocks in a reference frame in a different view. The derivation of disparity vectors for the partitioned CU is the same as the derivation of disparity vectors for the current texture or depth block as disclosed above. In one embodiment, the flags for n×n sub-blocks can be signaled according to the scan-line order or the zigzag order. The flag of the last partition can be omitted when all the other sub-blocks indicate that the inter-view mode is enabled.

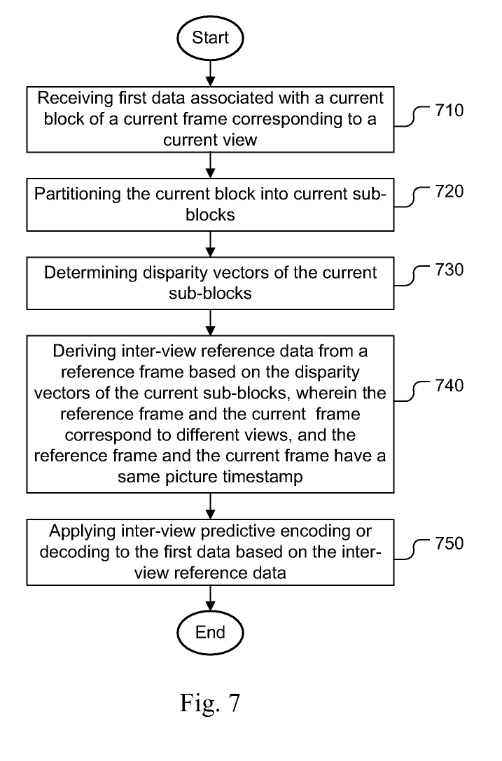

FIG. 7 illustrates an exemplary flowchart of a three-dimensional encoding or decoding system incorporating the sub-block inter-view mode according to an embodiment of the present invention. The system receives first data associated with a current block of a current frame corresponding to a current view as shown in step 710. For encoding, the first data associated with a current block corresponds to original pixel data or depth data to be coded. The first data may also correspond to residue pixel data to be inter-view predicted. In the latter case, the residue pixel data is further predicted using inter-view prediction to generate another residue data of the residue pixel data. For convenience, both the original pixel data and the residue pixel data are referred to as pixel data in this disclosure. The residue data refers to the residue data from the inter-view prediction. Accordingly, the residue data in this disclosure may correspond to residue pixel data or another residue data of residue pixel data. For decoding, the first data corresponds to the residue data to be used to reconstruct the pixel data or depth data for the current block. The first data may be retrieved from storage such as a computer memory, buffer (RAM or DRAM) or other media. The first data may also be received from a processor such as a controller, a central processing unit, a digital signal processor or electronic circuits that produce the first data. The current block is partitioned into current sub-blocks as shown in step 720 and disparity vectors of the current sub-blocks are determined as shown in step 730. The inter-view reference data is then derived from a reference frame based on the disparity vectors of the current sub-blocks as shown in step 740, wherein the reference frame and the current frame correspond to different views and a same picture timestamp. Inter-view predictive encoding or decoding is then applied to the first data based on the inter-view reference data as shown in step 750.

The flowchart shown above is intended to illustrate an example of inter-view prediction based on sub-block partition. A person skilled in the art may modify each step, re-arranges the steps, split a step, or combine steps to practice the present invention without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method for three-dimensional video encoding or decoding, the method comprising:
receiving first data associated with a current block of a current frame corresponding to a current view;
partitioning the current block into current sub-blocks;
determining disparity vectors of the current sub-blocks;
deriving inter-view reference data from a reference frame based on the disparity vectors of the current sub-blocks, wherein the reference frame and the current frame correspond to different views, and the reference frame and the current frame have a same picture timestamp; and
applying inter-view predictive encoding or decoding to the first data based on the inter-view reference data.

2. The method of claim 1, wherein the first data corresponds to residue data or a flag associated with the current block for the three-dimensional video decoding and the first data corresponds to pixel data or depth data of the current block for the three-dimensional video encoding.

3. The method of claim 2, wherein said applying inter-view predictive decoding comprises reconstructing the current block from the inter-view reference data, and said applying inter-view predictive encoding comprises generating the residue data or the flag associated with the current block.

4. The method of claim 3, wherein an inter-view Skip mode is signaled for the current block if motion information and the residue data are omitted.

5. The method of claim 3, wherein an interview Direct mode is signaled for the current block if motion information is omitted and the residue data is transmitted.

6. The method of claim 1, wherein said partitioning the current block partitions the current block into rectangular shaped sub-blocks having a same first size, square shaped sub-blocks having a same second size, or arbitrary shaped sub-blocks.

7. The method of claim 6, wherein the square shaped sub-blocks correspond to 4×4 sub-blocks or 8×8 sub-blocks and indication of the 4×4 sub-blocks or the 8×8 sub-blocks is signaled in Sequence Parameter Set (SPS) of a bitstream associated with the three-dimensional video encoding or decoding.

8. The method of claim 6, wherein the square shaped sub-blocks correspond to n×n sub-blocks and n is signaled in a sequence level, a slice level, or a coding unit (CU) level of a bitstream associated with the three-dimensional video encoding or decoding, wherein n is an integer.

9. The method of claim 6, wherein sub-block size is equal to a specified smallest size of a motion compensation block.

10. The method of claim 1, wherein said partitioning the current block is based on object boundaries of a depth map associated with the current frame.

11. The method of claim 10, wherein said partitioning the current block is based on object boundaries of a collocated block in the depth map corresponding to the current block.

12. The method of claim 1, wherein the inter-view reference data for the current block is obtained from corresponding sub-blocks of the reference frame and the corresponding sub-blocks are determined based on the disparity vectors of the current sub-blocks.

13. The method of claim 12, wherein the disparity vectors of the current sub-blocks are determined based on depth values of collocated sub-blocks in a depth map corresponding to the current block.

14. The method of claim 13, wherein the depth values are obtained from the depth map coded in an encoder side, decoded in a decoder side, or estimated in both the encoder and the decoder sides.

15. The method of claim 13, wherein the disparity vectors of the current sub-blocks are determined based on average, maximum, minimum, or median of all depth values or partial depth values within the collocated sub-block in the depth map respectively.

16. The method of claim 12, wherein the disparity vectors of the current sub-blocks are obtained from neighboring disparity vectors associated with neighboring sub-blocks of the current block coded in an inter-view mode.

17. The method of claim 16, wherein a first disparity vector of a first current sub-block adjacent to at least one neighboring block coded in the inter-view mode is derived from the neighboring disparity vectors of said at least one neighboring sub-block.

18. The method of claim 17, wherein the first disparity vector of said first current sub-block is derived from maximum, minimum, average, or median of the neighboring disparity vectors of said at least one neighboring sub-block.

19. The method of claim 16, wherein a first disparity vector of a first current sub-block not adjacent to any neighboring sub-block coded in the inter-view mode is derived from one or more adjacent current sub-blocks, wherein disparity vectors of said one or more adjacent current sub-blocks are already derived.

20. The method of claim 19, wherein if a second disparity vector of above-left sub-block of said first current sub-block is more similar to a third disparity vector of above sub-block of said first current sub-block than a fourth disparity vector of left sub-block of said first current sub-block, the first disparity vector is set to the fourth disparity vector; and the first disparity vector is set to the third disparity vector otherwise.

21. The method of claim 20, wherein a signal is used to identify whether the fourth disparity vector or the third disparity vector is selected as the first disparity vector.

22. The method of claim 16, wherein a first disparity vector of a first current sub-block not adjacent to any neighboring block coded in the inter-view mode is derived from a collocated block in a previous frame.

23. The method of claim 22, wherein the first disparity vector is set to a second disparity vector of the collocated block if the collocated block uses the inter-view mode.

24. The method of claim 22, wherein the first disparity vector is derived from depth values of the collocated block.

25. The method of claim 16, wherein a first disparity vector of a first current sub-block not adjacent to any neighboring block coded in the inter-view mode is derived from a collocated block in a previous frame or from one or more adjacent current sub-blocks, wherein disparity vectors of said one or more adjacent current sub-blocks are already derived, and a signal is signaled to indicate whether the collocated block or said one or more adjacent current sub-blocks is used to derive the first disparity vector.

26. The method of claim 12, wherein the disparity vectors of the current sub-blocks are derived from first neighboring sub-blocks of a collocated block of the reference frame coded in an inter-view mode or from second neighboring sub-blocks of a collocated depth block of one reference frame coded in the inter-view mode.

27. The method of claim 1, wherein a flag for the current block is incorporated in a bitstream associated with the three-dimensional video encoding or decoding and the flag is used to indicate if sub-block inter-view mode is enabled.

28. The method of claim 27, wherein the flag is signaled in a sequence level, a slice level, or a coding unit level of the bitstream.

29. The method of claim 27, wherein the flag is adaptively placed with respect to another flag according to mode information of adjacent blocks of the current block, wherein the flag is placed in a higher priority position than said another flag if majority of the adjacent blocks use the inter-view mode.

30. The method of claim 27, wherein a second flag is used for each current sub-block to indicate whether the inter-view predictive encoding or decoding is applied to the current sub-block and the second flags for the current sub-blocks are signaled in a line scan order or zigzag order across the current sub-blocks.

31. The method of claim 30, wherein the second flag for a last current sub-block is omitted if all other current sub-blocks use the inter-view predictive encoding or decoding.

32. The method of claim 1, wherein the current block corresponds to a coding unit (CU).

33. An apparatus for three-dimensional video encoding or decoding, the apparatus comprising:
means for receiving first data associated with a current block of a current frame corresponding to a current view;
means for partitioning the current block into current sub-blocks;
means for determining disparity vectors of the current sub-blocks;
means for deriving inter-view reference data from a reference frame based on the disparity vectors of the current sub-blocks, wherein the reference frame and the current frame correspond to different views and a same picture timestamp; and
means for applying inter-view predictive encoding or decoding to the first data based on the inter-view reference data.

34. The apparatus of claim 33, further comprising means for performing motion compensation, wherein said means for performing motion compensation is used to derive the inter-view reference data from the reference frame based on the disparity vectors of the current sub-blocks, the reference frame is used as a reference picture and the disparity vectors of the current sub-blocks are used as motion vectors for said means for performing motion compensation.
